(19) United States
(12) Patent Application Publication
(10) Pub. No.: US 2005/0084653 A1
(43) Pub. Date: Apr. 21, 2005

(54) Shaped bodies with self-cleaning properties and method for the production of such shaped bodies

(75) Inventors: Edwin Nun, Billerbeck (DE); Markus Oles, Hattingen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Creavis Gesellschaft F. Techn. U. Innovation Mbh, Marl (DE)

(21) Appl. No.: 10/501,924

(22) PCT Filed: Jan. 11, 2003
(86) PCT No.: PCT/EP03/00201

(30) Foreign Application Priority Data
Feb. 13, 2002 (DE) 102 05 783.4

(51) Int. Cl. B32B 1/00

(52) U.S. Cl. 428/143

(57) ABSTRACT

The invention relates to moldings with synthetic polymer surfaces which have self-cleaning properties. Self-cleaning surfaces and their advantages are well known. There are now various processes to obtain these surfaces. Two principal processes have become established, and one process is based on the securing of particles to surfaces, whereupon the particles produce elevations which produce the self-cleaning effect. The manner in which the invention presented here produces the surfaces is that synthetic polymer surfaces are swelled by a swelling agent which comprises suitable particles in suspension, the particles are embedded into the swollen surfaces, and after removal of the swelling agent the particles have been securely anchored within the synthetic polymer surface. Moldings thus produced have the advantage that they can be produced in the usual way and then, whatever the shape, provided with self-cleaning properties. Moldings of the invention may be drinking cups, drums, storage vessels, storage packs, splash guards, or else textile sheets and fabrics for textile buildings.

The invention relates to moldings with synthetic polymer surfaces which have self-cleaning properties, and also to a process for their production.

Various processes for treating surfaces to give the surfaces dirt- and water-repellent properties are known from surface technology. For example, it is known that if a surface is to have good self-cleaning properties the surface has to have a certain degree of roughness as well as a very hydrophobic surface. A suitable combination of structure and hydrophobic properties permits even small amounts of water set in motion on the surface to entrain adherent dirt particles and clean the surface (WO 96/04123; U.S. Pat. No. 3,354,022).

The prior art of EP 0 933 388 in relation to these surfaces is that these self-cleaning surfaces require an aspect ratio of >1 and a surface energy of less than 20 mN/m. The aspect ratio is defined here as the quotient derived from the average height in relation to the average width of the structure. The abovementioned criteria are found in the natural world, for example in the lotus leaf. The plant has a surface formed from a hydrophobic waxy material and having elevations, the mutual separation of which extends to a few μm. Water droplets come into contact substantially only with these peaks. There are many descriptions in the literature of water-repellent surfaces of this type.

Swiss Patent 268 258 describes a process which produces structured surfaces by applying powders, such as kaolin, talc, clay, or silica gel. Oils and resins based on organosilicon compounds are used (Examples 1 to 6) to secure the powders to the surface.

EP 0 909 747 teaches a process for producing a self-cleaning surface. The surface has hydrophobic elevations with a height of from 5 to 200 μm. A surface of this type is produced by applying a dispersion of pulverulent particles and of an inert material in a siloxane solution, and then curing. The structure-forming particles are therefore secured to the substrate by way of an auxiliary medium.

WO 00/58410 concludes that it is technically possible to render surfaces of articles artificially self-cleaning. The surface structures necessary for this, composed of elevations and depressions, have a separation in the range from 0.1 to 200 μm between the elevations of the surface structures, and an elevation height in the range from 0.1 to 100 μm. The materials used for this purpose have to be composed of hydrophobic polymers or of lastingly hydrophobicized materials. Swelling of the particles out of the carrier matrix has to be prevented. WO 00/58410 describes the structures and claims the formation of the same by spray-application of hydrophobic alcohols, such as 10-nonacosanol or alkanediols, such as 5,10-nonacosanediol. A disadvantage here is the inadequate stability of the self-cleaning surfaces, since detergents break down the structure.

The use of hydrophobic materials, such as perfluorinated polymers, for producing hydrophobic surfaces is known. A further development of these surfaces consists in structuring the surfaces in the μm range to nm range. U.S. Pat. No. 5,599,489 discloses a process in which a surface can be rendered particularly repellent by bombardment with particles of an appropriate size followed by perfluorination. Another process is described by H. Saito et al. in “Service Coatings International”, 4, 1997, pp. 168 et seq. Here, particles of fluoropolymers are applied to metal surfaces, whereupon the resultant surfaces are described as having markedly reduced wettability with respect to water and considerably reduced tendency toward icing.

JP 11171592 describes a water-repellent product and its production, the dirt-repellent surface being produced by applying a film to the surface to be treated, the film comprising fine particles made from metal oxide and comprising the hydrolyzate of a metal alkoxide or of a metal chelate. To consolidate this film, the substrate to which the film has been applied has to be sintered at temperatures above 400° C. The process is therefore suitable only for substrates which are stable even at temperatures above 400° C.

It was an object of the present invention to provide a process for producing self-cleaning surfaces, where only low levels of chemical and/or physical stress are required to act on the material which is provided with the self-cleaning properties.

Surprisingly, it has been found that a synthetic polymer surface which has been treated with a swelling agent, where the swelling agent comprises undissolved particles, has self-cleaning properties after removal of the swelling agent, since at least some of the particles are securely bonded to the surface thus forming elevations which give the synthetic polymer surface self-cleaning properties.

The present invention therefore provides moldings with synthetic polymer surfaces which have self-cleaning properties and have surface structures with elevations, characterized in that the elevations are formed by particles securely bonded to the synthetic polymer surface.

The present invention also provides a process for producing moldings with surfaces, all or part of which have elevations, characterized in that a surface of the moldings which is swollen by a swelling agent is treated with this swelling agent, where the swelling agent comprises undissolved particles, and after removal of the swelling agent and drying at least some of the particles, which form the elevations, are securely bonded to the surface of the moldings.

The manner in which the invention presented here produces the surfaces is that synthetic polymer surfaces are swelled by a swelling agent which comprises suitable particles in suspension, the particles are embedded into the swollen surfaces, and after removal of the swelling agent the particles have been securely anchored within the synthetic polymer surface. Moldings thus produced have the advantage that they can be produced in the usual way and then, whatever the shape, provided with self-cleaning properties.

The moldings of the invention have the advantage that the structure-forming particles are not secured by carrier material, thereby avoiding any unnecessarily large number of combinations of materials.

The process of the invention provides access to self-cleaning surfaces which comprise particles with a fissured structure, with no need to apply an additional emboss layer to the moldings.

Another advantage of the process of the invention is that surfaces susceptible to scratching are not damaged by the mechanical application of a carrier layer and/or of particles.

A factor which is proving very particularly advantageous is that moldings of any desired shape can be rendered self-cleaning. Even inner surfaces are included as long as they are accessible to the suspension of swelling agents and particles.

The main difference from the application of particles via a suspension of the same in solvents is the deeper and more secure anchoring of the structure-formers within the swollen polymer matrix. The swelling is reversible, i.e. the shape of the moldings is retained after the introduction of the structure-formers needed to produce the self-cleaning surface, and drying. This is also a decisive advantage over solvation, since solvation causes at least some loss of shape of the molding.

An explanation follows of the meaning of swelling for the purposes of the present invention. Swelling is mainly restricted to crosslinked polymers. If a chemically crosslinked macromolecule is introduced into various solvents it undergoes swelling until equilibrium has been reached, the severity of the swelling differing as a function of the efficacy of the solvent. The equilibrium corresponds to the limiting swelling value and has been achieved when the forces of dissolution which are attempting to dissolve the polymer completely are balanced with the forces of elastic resilience of the chemical crosslinking. ΔG=ΔGₘᵢₓ+ΔGₑₗ=0, where ΔGₘᵢₓ is the Gibbs mixing energy and ΔGₑₗ is the Gibbs energy of elasticity.

The swelling of non-crosslinked polymers is also sometimes described, but not as a function of solvent efficacy which can be defined via solubility parameters (Hans-Georg Elias, Makromoleküle [Macromolecules], Hüthig & Wepf Verlag Basle—Heidelberg—New York, 1981). In Polymere Werkstoffe [Polymeric materials], Georg Thieme Verlag Stuttgart—New York, 1984, Batzer describes swelling as a method of heat-setting which ameliorates adverse creasing behavior of fibers via treatment with swelling agents, e.g. steam at from 100 to 135° C.

The invention is described below by way of example, but is not restricted to those embodiments.

In the moldings of the invention with synthetic polymer surfaces at least part of which have self-cleaning properties and have surface structures with elevations, the elevations are formed by particles securely bonded to the synthetic polymer surface. These particles have been bonded directly to the synthetic polymer surface and have not been bonded by way of carrier systems or the like. The elevations present on at least part of the surface of the moldings ensure that these regions of the surface have low wettability.

The surfaces with self-cleaning properties preferably have elevations with an average height of from 50 nm to 25 μm and with an average separation of from 50 nm to 25 μm, preferably with an average height of from 50 nm to 25 μm and/or with an average separation of from 50 nm to 25 μm, and very particularly preferably with an average height of from 50 nm to 4 μm and/or an average separation of from 50 nm to 4 μm. The surfaces of the invention very particularly preferably have elevations with an average height of from 0.25 to 1 μm and with an average separation of from 0.25 to 1 μm. For the purposes of the present invention, the average separation of the elevations is the separation of the highest elevation of an elevation from the most adjacent highest elevation. If an elevation has the shape of a cone, the peak of the cone is the highest elevation of the elevation. If the elevation is a rectangular parallelepiped, the uppermost surface of the rectangular parallelepiped is the highest elevation of the elevation.

The wetting of solids may be described by using the contact angle made by a water droplet with the surface. A contact angle of 0 degree here implies complete wetting of the surface. The contact angle on fibers is usually measured by the Wilhelmy method. For this, the fiber is wetted by a liquid, and the force with which the fiber is drawn into the liquid due to surface tension is measured. The higher the contact angle, the lower the wettability of the surface. The aspect ratio is defined as the quotient derived from the height in relation to the width of the structure of the surface.

The surfaces of the invention with self-cleaning and water-repellent properties have a high aspect ratio of the elevations. The elevations of the surfaces of the invention preferably have an aspect ratio of from 0.5 to 20, with preference from 1 to 10. The aspect ratio is defined here as the ratio of the average height of the elevations to their average width.

It can be advantageous for the surfaces of the moldings to have the elevations applied to an overstructure with an average height of from 10 μm to 1 mm and with an average separation of from 10 μm to 1 mm.

The moldings may have the elevations on all surfaces or only on certain surfaces. The moldings of the invention preferably have the elevations on the inner surfaces and/or on the outer surfaces.

The material for the synthetic polymer surface of the moldings preferably comprises a material selected from poly(trifluoroethylene), poly(vinylidene fluoride), poly(chlorotrifluoroethylene), poly(hexafluoropropylene), poly(perfluoropropylene oxide), poly(fluoroalkyl acrylate), poly(fluoroalkyl methacrylate), poly(vinyl perfluoroalkyl ether), or comprises other polymers from perfluoroalkoxy compounds, poly(isobutene), poly(4-methyl-1-pentene), polycarbonates, poly(meth)acrylates, polyamides, PVC, polyethylenes, polypropylenes, aliphatic linear or branched alkenes, cyclic alkenes, polystyrenes, polyesters, polyether sulfones, polyacrylonitrile, or polyalkylene terephthalates, and polynorbornene, in the form of homo- or copolymer, or comprises a mixture of these. The material of the surface of the moldings very particularly preferably comprises poly(ethylene), poly(propylene), or poly(vinylidene fluoride).

The moldings may be either solid polymer articles or hollow polymer articles. The moldings may also be formed from metallic or wood moldings of any type sheathed by synthetic polymer.

The particles securely bonded to the surface and forming the elevations on the surface of the moldings have preferably been selected from silicates, minerals, metal oxides, metal powders, silicas, pigments, or polymers, very particularly preferably from fumed silicas, precipitated silicas, aluminum oxide, silicon oxide, doped silicates, fumed silicates, or pulverulent polymers.

It is preferable to use particles which have a particle diameter of 0.02 to 100 μm, particularly preferably from 0.1 to 50 μm, and very particularly preferably from 0.1 to 30 μm. It is also possible to use particles with diameters smaller than 500 nm. However, other suitable particles are those accreted from primary particles to give agglomerates or aggregates with a size of from 0.2 to 100 μm.

The particles which form the elevations of the structured surface preferably comprise particles whose surface has an irregular fine structure in the nanometer range. It can also be advantageous for the particles to have hydrophobic properties.

Particles whose use is preferred, in particular particles whose surface has an irregular fine structure in the nanometer range, are particles which comprise at least one compound selected from fumed silica, precipitated silicas, aluminum oxide, silicon dioxide, fumed and/or doped silicates, or pulverulent polymers.

The particles preferably have hydrophobic properties, and these hydrophobic properties may be attributable to the material properties of the materials themselves present on the surfaces of the particles, or else may be obtained via treatment of the particles with a suitable compound. The particles may be provided with hydrophobic properties prior to or after bonding to the surface.

Prior to or after bonding to the surfaces, the particles may be hydrophobicized by treatment with a compound from the group of the alkylsilanes, the fluoroalkylsilanes, or the disilazanes.

The particles whose use is very particularly preferred are described in more detail in the following. The particles used may come from a very wide variety of fields. For example, they may be silicates, doped silicates, minerals, metal oxides, aluminum oxide, silicas, or fumed silicates, Aerosils, or pulverulent polymers, e.g. spray-dried and agglomerated emulsions, or cryogenically milled PTFE. Particularly suitable particle systems are hydrophobicized fumed silicas, known as Aerosils. To generate the self-cleaning surfaces, hydrophobic properties are needed alongside the structure. The particles used may themselves be hydrophobic, for example PTFE. The particles may have been rendered hydrophobic, examples being Aerosil VPR 411 or Aerosil R 8200. However, they may also be hydrophobicized subsequently. It is not important here whether the particles are hydrophobicized prior to application or after application. Examples of particles which can be hydrophobicized by treatment with perfluoroalkylsilane followed by heat-conditioning are, for example, Aeroperl 90/30, Sipemat silica 350, aluminum oxide C, zirconium silicate, and vanadium-doped or VP Aeroperl P 25/20.

The particles which have been securely bonded to the surface have preferably been bonded to the surface of the moldings using at least from 5 to 90%, particularly preferably from 10 to 30%, from 31 to 60%, or from 61 to 90%, and very particularly from 10 to 25%, of their surface. This gives very durable bonding of the securely bonded particles to the surface of the molding.

The moldings of the invention are preferably produced by the process of the invention for producing moldings with surfaces part of which or all of which has elevations, the process being characterized in that a surface of the moldings which is swollen by a swelling agent is treated with this swelling agent, where the swelling agent comprises undissolved particles, and after removal of the swelling agent at least some of the particles are securely bonded to the surface of the moldings. The particles are preferably in suspension or dispersion in the swelling agent.

The (synthetic polymer) surface which undergoes some degree of swelling by a swelling agent preferably comprises polymers based on polycarbonates, on poly(meth)acrylates, on polyamides, on PVC, on polyethylenes, on polypropylenes, on polystyrenes, on polyesters, on polyether sulfones, on aliphatic linear or branched alkenes, on cyclic alkenes, on polyacrylonitrile, or on polyalkylene terephthalates, or else comprises their mixtures or copolymers.

The surface of the moldings made from the polymers mentioned may be inherently present if the molding has been manufactured entirely from that material. However, the polymers may also be applied as a coating to other materials. For example, part or all of moldings made from glass or metal may also be provided with a surface made from one of the polymers mentioned, e.g. by dipping into a polymer melt and then solidifying the melt, or by applying a reactive polymer adhesive and consolidating the adhesive on the molding.

Suitable swelling agents do not dissolve a polymer surface. Instead, the surface becomes undefined in a strict sense via embedding of solvent molecules, and becomes soft. This permits at least some penetration into the surface of particles as claimed in this application, as well as solvent molecules. The compounds to be used as swelling agents are therefore those which are poor solvents for the polymer to be treated, therefore requiring markedly more time than good solvents for the solution process, or else solvents whose solvent power has been reduced by addition of non-solvent. The result is that the only macroscopic effect taking place is swelling of the uppermost polymer layers. This method also avoids entire or partial break away of the synthetic polymer surface or polymer surface.

There are polymers, e.g. high-pressure polyethylene (LDPE) or polypropylene (PP) which are not soluble in any solvent at room temperature. These semicrystalline polyolefins can be dissolved only after the crystalline regions have undergone complete melting. In the presence of good solvents this often takes place at temperatures well below the crystallite melting point observed in the absence of the solvent. Good solvents, for example aromatic hydrocarbons, such as p-xylene, or aliphatic hydrocarbons, such as decalin, dissolve LDPE completely only at temperatures above 70° C. High-density polyethylene (HDPE) dissolves completely in p-xylene only above 100° C. At lower temperatures all that happens is limited swelling, increasing with rising efficacy of the solvent and with decreasing degree of crystallization. This is the basis of the good chemicals resistance of these specified polyolefins at moderate temperatures with respect to most non-oxidizing agents and, respectively, solvents.

If there is no precondition, such as semicrystallinity, suitable swelling agents can be found by lowering solvent efficacy. For example, polymethyl methacrylate is soluble in toluene but not in ethanol, cyclohexane, or water. If cyclohexane is added to the toluene solvent it is possible to slow the rate of dissolution progressively and, when there is at least a certain amount of cyclohexane in the toluene, suppress the dissolution process. What takes place is swelling.

Another way of finding suitable swelling agents can be to mix non-solvents. For example, atactic polystyrene is soluble neither in acetone nor in cyclohexane. However, if these two non-solvents are mixed, mixing ratios at which polystyrene swells are rapidly arrived at. Indeed, it is possible to reach mixing ranges where atactic polystyrene is dissolved.

After completion of the swelling process or of the swelling procedure and subsequent drying, the particles which form the surface structures made from elevations have been securely embedded into the upper polymer layers accessible to the swelling agent. The subsequent removal of the swelling agent reverses the process of swelling, and the particles have been securely anchored within the synthetic polymer surface. The swelling of the surfaces is therefore an indispensable feature of the process of the invention for producing moldings with self-cleaning surfaces which involve no carrier layer.

The swelling agent used may be at least one compound suitable as a swelling agent for the appropriate surface and selected from the group of the alcohols, the glycols, the ethers, the glycol ethers, the ketones, the esters, the amides, the nitro compounds, the halogenated hydrocarbons, and the aliphatic and aromatic hydrocarbons, or a mixture of these. At least one compound suitable as a swelling agent for the appropriate surface and selected from methanol, ethanol, propanol, butanol, octanol, cyclohexanol, phenol, cresol, ethylene glycol, diethylene glycol, diethyl ether, dibutyl ether, anisole, dioxane, dioxolane tetrahydrofuran, monoethylene glycol ether, diethylene glycol ether, triethylene glycol ether, polyethylene glycol ether, acetone, butanone, cyclohexanone, ethyl acetate, butyl acetate, isoamyl acetate, ethylhexyl acetate, glycol ester, dimethylformamide, pyridine, N-methylpyrrolidone, N-methylcaprolactone, acetonitrile, carbon disulfide, dimethyl sulfoxide, sulfolane, nitrobenzene, dichloromethane, chloroform, carbon tetrachloride, trichloroethene, tetrachloroethene, 1,2-dichloroethane, and chlorophenol, or (hydro)chlorofluorocarbons, petroleum spirits, petroleum ether, cyclohexane, methylcyclohexane, decalin, tetralin, terpenes, benzene, toluene, and xylene, or a mixture of these, use as swelling agent.

For amorphous polymers, the solubility parameters for the polymer and the solubility parameters of the solvents can be used for approximate prediction of a swelling agent. Solubility parameters are tabulated in the abovementioned book by Hans-Georg Elias (1981). An aid to approximate prediction of the dissolution process is given. Swelling occupies the border region between dissolution and non-dissolution. The solubility parameter concept cannot be utilized to determine swelling for crystalline or semicrystalline polymers at temperatures below the crystallite melting point. Here, simple experiments based both on solvent efficacy and on the effect of temperature can be utilized to identify the swelling agent.

The table below gives by way of example some swelling agent-polymer combinations which are suitable for use in the process of the invention. The skilled worker will readily find other combinations.

| Swelling agent | Polymer |
|---|---|
| Tetrahydrofuran:ethanol 60:40 (% by weight) | Polystyrene |
| Decalin:N-methylpyrrolidone 90:10 | Polyethylene |
| (% by weight) | |
| Decalin:cyclohexanone 50:50 (% by weight) | Polyethylene |
| Decalin:cyclohexanone 50:50 (% by weight) | Polypropylene |
| Decalin:tetrahydrofuran 50:50 (% by weight) | Polypropylene |
| Decalin:N-methylpyrrolidone 90:10 | Polyethylene |
| (% by weight) | |
| Cyclohexanone:ethanol 20:80 (% by weight) | Polyvinyl chloride |
| Cyclohexanone:tetrahydrofuran 20:80 | Polyvinyl chloride |
| (% by weight) | |

Simple testing will provide the skilled worker with suitable swelling agents as a function of the polymer material used.

It can be advantageous for the swelling agent which comprises the particles to have a temperature of from −30° C. to 300° C., preferably from 15 to 100° C., and very particularly preferably from 25 to 49° C., from 50 to 85° C., or from 86 to 100° C., prior to application to the surface.

The particles present in the swelling agent are preferably particles which comprise at least one material selected from the silicates, minerals, metal oxides, metal powders, silicas, pigments, or polymers. Preference is given to the use of particles which have a particle diameter of from 0.02 to 100 μm, particularly preferably from 0.1 to 50 μm, and very particularly preferably from 0.1 to 30 μm. It is also possible to use particles with diameters smaller than 500 nm. However, other suitable particles are those accreted from primary particles to give agglomerates or aggregates with a size of from 0.2 to 100 μm.

Preference is given to the use of particles, in particular particles whose surface has an irregular fine structure in the nanometer range, which comprise at least one compound selected from fumed silica, precipitated silicas, aluminum oxide, silicon dioxide, fumed and/or doped silicates, or pulverulent polymers.

The particles preferably have hydrophobic properties, and these hydrophobic properties may be attributable to the material properties of the materials themselves present on the surfaces of the particles, or else may be obtained by treating the particles with a suitable compound. The particles may be provided with hydrophobic properties prior to or after bonding to the surface.

Prior to or after bonding to the surface, the particles may be hydrophobicized by treatment with a compound from the group of the alkylsilanes, the fluoroalkylsilanes, or the disilazanes.

The particles whose use is very particularly preferred are described in more detail in the following. The particles used may come from a wide variety of fields. For example, they may be silicates, doped silicates, minerals, metal oxides, aluminum oxide, silicas, or fumed silicates, Aerosils, or pulverulent polymers, e.g. spray-dried and agglomerated emulsions, or cryogenically milled PTFE. Particularly suitable particle systems are hydrophobicized fumed silicas, known as Aerosils. To generate the self-cleaning surfaces, hydrophobic properties are needed alongside the structure. The particles used may themselves be hydrophobic, for example PTFE. The particles may have been rendered hydrophobic, examples being Aerosil VPR 411 or Aerosil R 8200. However, they may also be hydrophobicized subsequently. It is not important here whether the particles are hydrophobicized prior to application or after application. Examples of particles which can be hydrophobicized by treatment with perfluoroalkylsilane followed by heat-conditioning are, for example, Aeroperl 90/30, Sipemat silica 350, aluminum oxide C, zirconium silicate, and vanadium-doped or VP Aeroperl P 25/20.

The inventive treatment of the surfaces of the moldings preferably takes place by dipping the moldings into the swelling agent which comprises the particles. Depending on the shape of the molding, the swelling agent comprising the particles may also be charged into cavities of the molding and be uniformly distributed within this cavity by swiveling the molding. The duration of the dipping of the moldings or of the action of the swelling agent on the surface of the molding depends on the rate of swelling of the polymer in the swelling agent, but is preferably less than 5 minutes, with preference from 1 second to 5 minutes, particularly preferably from 1 to 20 seconds, from 20 seconds to 1.5 minutes, or from 1.5 to 2 minutes. From 5 to 15 seconds of dipping of the moldings into the swelling agent is very particularly preferred. After the dipping of the moldings into the swelling agent, these are removed from the swelling agent and dried. The drying may take place slowly in air. However, the drying may also take place by thermal treatment at from 30 to 70° C., preferably from 40 to 60° C.

There are also other suitable processes for applying the swelling agent, e.g. in particular application by spraying, spreading, or doctoring.

Examples of the moldings of the invention are drinking vessels, drums, storage vessels, storage packs, splash guards, and also textile sheets and fabrics for textile building. Another aspect of the present invention is therefore textiles, e.g. wovens, knitteds, felts, or nonwovens, and vessels produced by a process of the invention.

The process of the invention is described using the example below, but there is no intention that the invention be restricted to this example.

### EXAMPLE

A 1% strength suspension of Aerosil R 8200 is prepared in tetrahydrofuran:ethanol 60:40. A sheet of polystyrene is dipped into this for 5 seconds. After drying, the roll-off angle for a water droplet is determined by applying a droplet to the sheet and constantly increasing the inclination of the sheet to determine the angle at which the droplet rolls off from the sheet. For a water droplet of size 40 μl the roll-off angle determined was 14.2°.

### Comparative Example 1

A polystyrene sheet is dipped for 5 seconds into a 1% strength suspension of Aerosil R 8200 in tetrahydrofuran. The roll-off angle determined as in Example 1 after drying for a droplet of size 40 μl is 30.0°.

It can readily be seen that the sheet of Example 1 has a markedly lower roll-off angle than the sheet of the comparative example. Since the roll-off angle can be utilized as a measure of self-cleaning properties, it can therefore also be seen that a sheet treated according to the invention has markedly better self-cleaning properties than sheets where use was made of a solvent not suitable for swelling the appropriate polymer.

1. A molding with synthetic polymer surfaces which have self-cleaning properties and have surface structures with elevations,
characterized in that
the elevations are formed by particles which have been securely bonded to the synthetic polymer surface and which have hydrophobic properties, the particles having been bonded directly into the synthetic polymer surface, rather than having been bonded by way of carrier systems or the like.

2. The molding as claimed in claim 1,
characterized in that
the elevations have an average height of from 50 nm to 25 μm and an average separation of from 50 nm to 25 μm.

3. The molding as claimed in claim 1,
characterized in that
the elevations have an average height of from 50 nm to 4 μm and/or an average separation of from 50 nm to 4 μm.

4. The molding as claimed in claim 1,
characterized in that
the elevations have an aspect ratio of from 0.5 to 20.

5. The molding as claimed in claim 4,
characterized in that
the elevations have an aspect ratio of from 1 to 10.

6. The molding as claimed in claim 1,
characterized in that
the elevations have been applied to the inner surface of the moldings.

7. The molding as claimed in claim 1,
characterized in that
the elevations have been applied to the outer surface of the moldings.

8. The molding as claimed in claim 1,
characterized in that
the synthetic polymer surface of the moldings comprises a material selected from poly(trifluoroethylene), poly(vinylidene fluoride), poly(chlorotrifluoroethylene), poly(hexafluoropropylene), poly(perfluoropropylene oxide), poly(fluoroalkyl acrylate), poly(fluoroalkyl methacrylate), poly(vinyl perfluoroalkyl ether), or comprises other polymers from perfluoroalkoxy compounds, poly(isobutene), poly(4-methyl-1-pentene), polycarbonates, poly(meth)acrylates, polyamides, PVC, polyethylenes, polypropylenes, aliphatic linear or branched alkenes, cyclic alkenes, polystyrenes, polyesters, polyether sulfones, polyacrylonitrile, or polyalkylene terephthalates, and polynorbornene, in the form of homo- or copolymer, or comprises a mixture of these.

9. The molding as claimed in claim 1,
characterized in that
the surface of the particles has an irregular fine structure in the nanometer range.

10. The molding as claimed in claim 1,
characterized in that
the moldings comprise particles selected from silicates, minerals, metal oxides, metal powders, silicas, pigments, or polymers.

11. The molding as claimed in claim 1,
characterized in that
the moldings comprise particles selected from fumed silicas, precipitated silicas, aluminum oxide, silicon oxide, doped silicates, fumed silicates, or pulverulent polymers.

12. A process for producing moldings with surfaces, all or part of which have elevations,
characterized in that
a surface of the moldings which is swollen by a swelling agent is treated with this swelling agent, where the swelling agent comprises undissolved particles having hydrophobic properties, and after removal of the swelling agent and drying at least some of the particles are securely bonded to the surface of the moldings.

13. The process as claimed in claim 12,
characterized in that
the particles have been suspended in the swelling agent.

14. The process as claimed in claim 12,
characterized in that
the surface which is solvated by a swelling agent comprises polymers based on polycarbonates, on poly(meth)acrylates, on polyamides, on PVC, on polyethylenes, on polypropylenes, on aliphatic linear or branched alkenes, on cyclic alkenes, on polystyrenes, on polyesters, on polyether sulfones, on polyacrylonitrile, or on polyalkylene terephthalates, or else comprises their mixtures or copolymers.

15. The process as claimed in claim 12,
characterized in that
the swelling agent used comprises at least one compound suitable as a swelling agent for the appropriate surface and selected from the group of the alcohols, the glycols, the ethers, the glycol ethers, the ketones, the esters, the amides, the nitro compounds, the halogenated hydrocarbons, and the aliphatic and aromatic hydrocarbons, or a mixture of these.

16. The process as claimed in claim 15,
characterized in that
the swelling agent used comprises at least one compound suitable as a swelling agent for the appropriate surface and selected from methanol, ethanol, propanol, butanol, octanol, cyclohexanol, phenol, cresol, ethylene glycol, diethylene glycol, diethyl ether, dibutyl ether, anisole, dioxane, dioxolane, tetrahydrofuran, monoethylene glycol ether, diethylene glycol ether, triethylene glycol ether, polyethylene glycol ether, acetone, butanone, cyclohexanone, ethyl acetate, butyl acetate, isoamyl acetate, ethylhexyl acetate, glycol ester, dimethylformamide, pyridine, N-methylpyrrolidone, N-methylcaprolactone, acetonitrile, carbon disulfide, dimethyl sulfoxide, sulfolane, nitrobenzene, dichloromethane, chloroform, carbon tetrachloride, trichloroethene, tetrachloroethene, 1,2-dichloroethane, and chlorophenol, or comprises (hydro)chlorofluorocarbons, petroleum spirits, petroleum ether, cyclohexane, methylcyclohexane, decalin, tetralin, terpenes, hexafluoroisopropanol, benzene, toluene, and xylene, or a mixture of these.

17. The process as claimed in claim 12,
characterized in that
the swelling agent which comprises the particles has a temperature of from −30° C. to 150° C., preferably from 15 to 100° C., prior to application to the surface.

18. The process as claimed in claim 12,
characterized in that
the swelling agent comprises particles which have an average particle diameter of from 0.02 to 100 μm.

19. The process as claimed in claim 18,
characterized in that
the swelling agent comprises particles which have an average particle diameter of from 0.1 to 30 μm.

20. The process as claimed in claim 12,
characterized in that
the swelling agent comprises particles selected from silicates, minerals, metal oxides, metal powders, silicas, pigments, or polymers.

21. The process as claimed in claim 12,
characterized in that
the particles have hydrophobic properties by virtue of treatment with a suitable compound.

22. The process as claimed in claim 21,
characterized in that
the particles are provided with hydrophobic properties prior to or after bonding to the surface.

23. A vessel with a synthetic polymer surface which has self-cleaning properties and has surface structures with elevations, the production process being as claimed in claim 12.

24. A textile with a synthetic polymer surface which has self-cleaning properties and has surface structures with elevations, the production process being as claimed in claim 12.
